(19) United States
(12) Patent Application Publication
(10) Pub. No.: US 2012/0031641 A1
(43) Pub. Date: Feb. 9, 2012

(54) MEDIUM-VOLTAGE CABLE

(75) Inventor: Panch Svensson, Varnamo (SE)

(73) Assignee: Trelleborg Forsheda Building AB, Vamamo (SE)

(21) Appl. No.: 13/138,475

(22) PCT Filed: Mar. 12, 2010
(86) PCT No.: PCT/EP2010/053149

§ 371 Date: Oct. 6, 2011

(30) Foreign Application Priority Data
Mar. 16, 2009 (EP) 09155274.5

(51) Int. Cl. H01B 9/02; H01B 1/24

(52) U.S. Cl. 174/102 SC; 252/511

(57) ABSTRACT

A cable for transmitting electrical power at a voltage between 5 and 49 kV includes a conductive cable core and an insulation layer for insulating the cable core, the insulation layer including from 50 to 99.9% of cross linked polyethylene, and from 0.1 to 50% of ethylene-alkyl(meth)acrylate and/or ethylene vinyl acetate. In at least one embodiment, the insulation layer is provided with a strippable outer semi conductive screen, which includes from 20 to 80% by weight of a composition of at least one copolymer selected from the group consisting of ethylene-alkyl (meth)acrylate carbon monoxides. The combination of materials in the insulator and the semi conductive screen provides for high water-tree resistance of the insulator and strippability of the semi conductive screen.

### FIELD OF THE INVENTION

The present invention relates to a medium-voltage cable comprising a conductive cable core, an insulation layer for insulating the cable core, and an outer semi conductive insulation shield.

### BACKGROUND OF THE INVENTION

A cable for transmitting medium-voltage, i.e. 5-49 kV, electrical power comprises at least one conductive cable core, which is covered by a polymer layer for insulation. The polymer layer normally comprises at least three layers:
a) an inner, relatively thin semi conductive layer;
b) a relatively thick insulating layer, outside the inner semi conductive layer; and
c) an outer, relative thin semi conductive layer, forming an insulation shield, outside the insulating layer.

The purpose of the semi conductive layers is to distribute the electrical field across the insulating layer over the cable surface, which reduces the risk of disruptive breakdown damaging the insulating layer. For such purposes, the semi conductive layers should have a volume resistivity, as measured according to the standard ASTM D257, of from 10 Ohm.cm to 20 000 Ohm.cm, which is used as the definition of “semi conductive” throughout this disclosure. Any granulate or compound for forming such a layer may, of course, have a resistivity outside this range, and still be viable for forming a semi conductive layer having a resistivity within this range.

The polymer layer, i.e. the insulating and semi conductive layers, should preferably be stable over time, and resistant to heat and humidity. For some applications, and in some markets, there is also a need for cables allowing the outer semi conductive layer to be stripped from the insulator. Such cables normally have an insulator of either an ethylene-propylene rubber (EPR) copolymer, or of a cross linked polyethylene homopolymer (commonly abbreviated PEX or XLPE), as several polymers suitable for semi conductive layers, exhibiting strippability from those insulators, are known and readily available.

There are some drawbacks with known cables having a strippable semi conductive layer. For example, EPR is expensive; it generally costs about twice as much as polyethylene, and the extrusion of EPR consumes more energy than extrusion of PEX. Insulating layers of PEX homopolymers, on the other hand, are susceptible to water-tree formation as they are exposed to humidity and high voltages over time, thereby reducing the life expectancy of the cable and increasing the risk of a disruptive breakdown. This is to some extent compensated for by adding water-tree retardants (WTR) to the insulator. Unfortunately, extrusion of WTR-PEX can be troublesome, as many WTR additives are prone to leave deposits in processing equipment, thereby increasing the needed frequency of production stoppages for cleaning the equipment.

The predominant material for strippable semi conductive layers on EPR and water-tree resistant PEX insulators is a copolymer of ethylene vinyl acetate (EVA), mixed with nitrile-butadiene rubber (NBR) and carbon black. “Strippable shields with Improved Thermal Stability and Faster Cable Extrusion Rate”, 6^{th} International Conference on Insulated Power Cables, JICABLE '03, describes the current state-of-the-art regarding semi conductive compounds that are strippable from a water-tree resistant cross linked polyethylene insulator.

### SUMMARY OF THE INVENTION

It is an object of the present invention to solve, or at least mitigate, parts or all of the above mentioned problems. To this end, there is provided a cable for transmitting electrical power at a voltage between 5 and 49 kV, the cable comprising

a conductive cable core;

an insulation layer for insulating the cable core, the insulation layer comprising from 50 to 99.9% by weight of cross linked polyethylene, and from 0.1 to 50% by weight of at least one copolymer selected from the group consisting of ethylene-alkyl(meth)acrylates and ethylene vinyl acetate; and

an outer semi conductive screen, forming an outer layer on the insulation layer, and comprising from 20 to 80% by weight of a composition (A) of at least one copolymer selected from the group consisting of ethylene-alkyl (meth)acrylate carbon monoxides. Thanks to the invention, a strippable semi conductive screen may be provided on a relatively inexpensive water-tree resistant cable insulator, without the drawbacks of WTR additives. The copolymer content of the insulation layer provides the insulation layer with water-tree resistance, while the ethylene-alkyl(meth)acrylate carbon monoxide makes the semi conductive screen strippable from the insulation layer.

In an embodiment presenting a particularly strong water-treeing resistance, the insulation layer comprises from 50 to 90% by weight of cross linked polyethylene, and from 10 to 50% by weight of at least one copolymer selected from the group consisting of ethylene-alkyl(meth)acrylates and ethylene vinyl acetate.

In a preferred embodiment, the outer semi conductive screen comprises from 30 to 70% by weight of said composition (A) of at least one copolymer selected from the group consisting of ethylene-alkyl(meth)acrylate carbon monoxides.

Preferably, the outer semi conductive screen presents an adhesion to the insulation layer of from 5 to 50 N/cm, and more preferably from 10 to 30 N/cm.

Preferably, said at least one copolymer selected from the group consisting of ethylene-alkyl(meth)acrylate carbon monoxides, of said composition (A), comprises from 25 to 70% by weight of ethylene; from 20 to 50% by weight of at least one alkyl(meth)acrylate; and from 5 to 25% by weight of carbon monoxide. Those intervals have been found to yield a suitable level of adhesion. In one embodiment, said at least one copolymer selected from the group consisting of ethylene-alkyl(meth)acrylate carbon monoxides, of said composition (A), comprises from 25 to 50% by weight of said at least one alkyl(meth)acrylate.

Preferably, an alkyl of said at least one copolymer selected from the group consisting of ethylene-alkyl(meth)acrylate carbon monoxides, of said composition (A), is butyl, since ethylene butyl(meth)acrylate carbon monoxide has a high polarity, thereby resulting in a high strippability, while being readily available on the market.

Preferably, the polyethylene of the insulator is a low-density polyethylene (LDPE), as those have proven particularly suitable for medium voltage cable insulators.

In one preferred embodiment, the outer semi conductive screen further comprises from 5 to 30% by weight of NBR; and from 20 to 40%, and even more preferred from 30 to 40% by weight of carbon black. The use of a substantial fraction of NBR in the semi conductive screen improves its viscosity, and thereby makes it easier to extrude. Furthermore, by adding a carefully selected amount of NBR, also the adhesion of the semi conductive layer to the insulator can be adjusted. The carbon black serves primarily for adjusting the conductivity of the semi conductive screen to a level suitable for semi conductive screens.

According to another aspect of the invention, parts or all of the above mentioned problems are solved, or at least mitigated, by a polymer mixture for preparing an outer semi conductive screen for a cable, the mixture comprising from 5 to 30% by weight of NBR; from 20 to 40% by weight of carbon black; and from 20 to 80% by weight of a composition (A) of at least one copolymer selected from the group consisting of ethylene-alkyl(meth)acrylate carbon monoxides, or of a composition (A) of comonomers for forming a copolymer selected from the group consisting of ethylene-alkyl(meth)acrylate carbon monoxides. Thanks to the invention, a strippable semi conductive screen having good extrusion properties may be provided on a relatively inexpensive water-tree resistant cable insulator. In a preferred embodiment, the polymer mixture comprises from 30 to 70% by weight of a composition (A) of at least one copolymer selected from the group consisting of ethylene-alkyl (meth)acrylate carbon monoxides, or of a composition (A) of comonomers for forming a copolymer selected from the group consisting of ethylene-alkyl (meth)acrylate carbon monoxides. According to one embodiment, the polymer mixture comprises from 30 to 40% by weight of carbon black.

Preferably, said at least one copolymer selected from the group consisting of ethylene-alkyl(meth)acrylate carbon monoxides, of said composition (A), or said composition (A) of comonomers, comprises from 25 to 70% by weight of ethylene; from 20 to 50% by weight of at least one alkyl (meth)acrylate; and from 5 to 25% by weight of carbon oxide. Even more preferred, said at least one copolymer selected from the group consisting of ethylene-alkyl(meth)acrylate carbon monoxides, of said composition (A), or said composition (A) of comonomers, comprises from 25 to 50% by weight of at least one alkyl(meth)acrylate.

Preferably, an alkyl of said at least one copolymer selected from the group consisting of ethylene-alkyl(meth)acrylate carbon monoxides, of said composition (A), or an alkyl of said composition (A) of comonomers, is butyl.

According to yet another aspect of the invention, parts or all of the above mentioned problems are solved, or at least mitigated, by the use of a copolymer selected from the group consisting of ethylene-alkyl(meth)acrylate carbon monoxides for reducing the adhesive force between copolymer layers in a cable.

Preferably, said copolymer selected from the group consisting of ethylene-alkyl(meth)acrylate carbon monoxides comprises from 25 to 70% by weight of ethylene; from 20 to 50% by weight of at least one alkyl (meth)acrylate; and from 5 to 25% by weight of carbon oxide.

Preferably, an alkyl of said at least one copolymer selected from the group consisting of ethylene-alkyl(meth)acrylate carbon monoxides is butyl.

### BRIEF DESCRIPTION OF THE DRAWING

The above, as well as additional objects, features and advantages of the present invention, will be better understood through the following illustrative and non-limiting detailed description of a preferred embodiment of the present invention, with reference to the appended drawing, wherein:

FIG. 1 is a diagrammatic view in section of a medium-voltage cable.

### DETAILED DESCRIPTION OF THE EXEMPLARY EMBODIMENTS

The introduction briefly describes current state-of-the-art in the field of water-tree resistant insulators for strippable semi conductive coatings. In the field of cables with non-strippable semi conductive layers, on the other hand, water-tree formation is generally not a problem, since the composition of the insulation layer can be made without regard to the strippability of an outer semi conductive layer. Insulators of non-strippable cables usually comprise a terpolymer of either EVA (ethylene-vinyl acetate) or EEA (ethylene-ethyl acrylate), and ethylene. Such a terpolymer is not prone to forming watertrees, but on the other hand results in a permanently bonded semi conductive shield. The water-tree resistance of the insulation layer appears already at concentrations of EVA or EEA as low as 0.1% by weight; however, so does the tendency to form a strong bond to the outer semi conductive screen. Detailed descriptions on how such insulating layers may be composed are given in EP 1916672 A1.

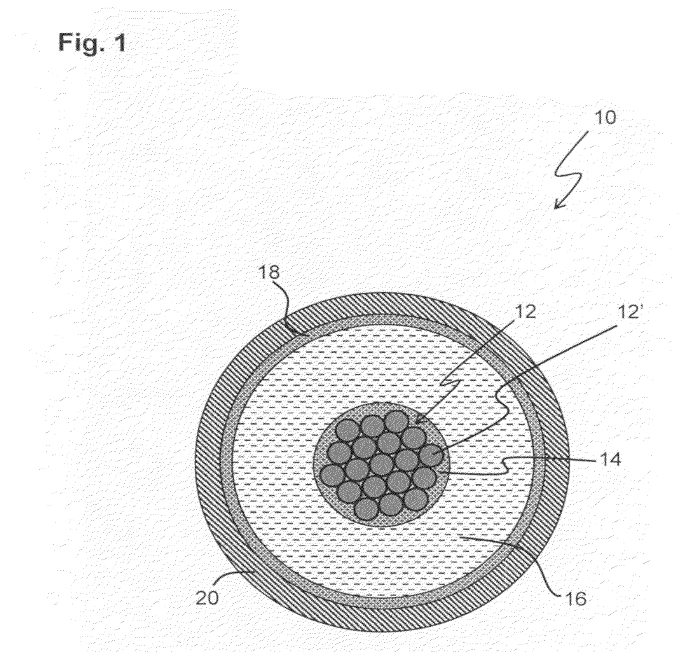

FIG. 1 illustrates a medium-voltage cable, i.e. a cable for electrical power transmission applications in the range 5-49 kV. The cable 10 comprises a central conductor 12 made of stranded copper wires 12′. A first, inner semi conductive layer 14 is deposited directly onto the conductor 12. The inner semi conductive layer 14 serves for smoothing the conductor's 12 interface towards an insulator layer 16, which electrically insulates the conductor 12 and the inner semi conductive layer 14 from the electrical (ground) potential surrounding the cable 10. A second, outer semi conductive layer 18 is deposited onto the insulator layer 16. The outer semi conductive layer 18 serves for distributing the electrical field, which is present across the insulator 16 when a voltage is applied to the conductor 12, evenly over the insulator area. Additional layers 20, such as water barriers and/or jackets for mechanical protection, may be present outside the outer semi conductive layer 18.

The outer semi conductive layer 18 is strippable from the insulator layer 16, such that the outer semi conductive layer 18 may be removed from the insulator layer 16 without significantly damaging the surface of the insulator layer 16, and without leaving any significant residues of semi conductive polymer on the surface of the insulator layer 16 after stripping. Strippable is, in this disclosure, defined as having an adhesion of from 5 to 50 N/cm, measured as the force required to peel off a strip of the outer semi conductive layer 18, cut to a width of 1 cm, from the surface of the insulator 16, while pulling at a speed of 50 mm/min. This method of measuring is described in more detail in the AFNOR standard NF C33-223. Ideally, the adhesion should however be in the range 10 to 30 N/cm for optimal strippability.

The insulating layer 16 consists of an LDPE-EEA copolymer that is formed by cross-linking a compound that consists of about 80% by weight of low-density polyethylene (LDPE), wherein low-density is defined as being in the range 0.910-0.940 g/cm³, and 20% by weight of ethylene-ethyl acrylate (EEA). A peroxide is used as a cross-linking agent. The EEA component effectively counteracts the formation of water-trees. An example of a suitable ethylene-ethyl acrylate compound consists of 10% ethylene, and 90% ethyl acrylate. An example of a suitable LDPE is Borealis SuperCure LC8205R, which is in fact intended for use with permanently bonded insulation shields. However, even though less preferred, also other types of polyethylenes, e.g. high-density polyethylene (HDPE), can be used instead of LDPE. The polyethylene may be cross-linked with other components instead of or in combination with EEA, e.g. ethylene butyl acrylate (EBA) and/or other ethylene-alkyl acrylates (EAA), and/or ethylene vinyl acetate (EVA) for applications having less demanding requirements on heat stability during vulcanization.

The inner and outer semi conductive layers 14, 18 consist of a mixture of 30% by weight of carbon black, 20% by weight of nitrile-butadiene rubber (NBR), and 50% by weight of a terpolymer of ethylene, butyl acrylate, and carbon monoxide (EBA-CO).

A suitable carbon black for the semi conductive composition above is Cabot Corporation's Vulcan XC500.

Preferably, the NBR is an acrylonitrile-butadiene rubber having a high content, ideally 35-50%, of acrylonitrile (ACN). An example of an NBR that is suitable for the semi conductive composition above, and having an ACN content of 44%, is Perbunan 4456F, available from LAXNESS Deutschland GmbH. The NBR serves for adjusting the viscosity of the rubber mix, thereby making it easier to extrude, but also contributes to the strippability of the mix. However, it is the EBA-CO, or in more general terms, the ethylene-alkyl (meth)acrylate carbon monoxide, that is the key ingredient for strippability, making it possible to obtain a semi conductive coating that is strippable from an insulator that consists of a copolymer of EVA and/or EAA, and PEX.

A suitable EBA-CO is an ethylene n-butyl acrylate carbon monoxide (EnBA-CO), sold by Dupont under the trade name Elvaloy HP661.

A semi conductive layer formed from the compound of EnBA-CO, carbon black and NBR described in detail above, co-extruded onto an insulator of LDPE-EEA according to the description hereinbefore, presents an adhesion of about 18 N/cm. By varying the process parameters of the extrusion and vulcanization, it is possible to vary this adhesion somewhat; greater variations may of course be obtained by varying the relative proportions of the constituents in the composition. EBA-CO, compared to e.g. EVA, also offers a higher resistance to heat during vulcanization, thereby allowing for faster extrusion, leading to a higher production speed and a lower cost per produced meter of cable.

Instead of, or in combination with EBA-CO, but somewhat less preferred due to higher cost or less abundant availability on the market, also other ethylene-alkyl(meth)acrylate carbon monoxide (EAA-CO) copolymers can be used for achieving a strippable semi conductive layer. Preferably, the EAA-CO comprises at least one copolymer selected from the group consisting of ethylene-alkyl(meth)acrylate carbon monoxides. Preferably, said at least one copolymer selected from the group consisting of ethylene-alkyl (meth)acrylate carbon monoxides comprises from 25 to 70% by weight of ethylene; from 20 to 50% by weight of at least one alkyl(meth)acrylate; and from 5 to 25% by weight of carbon oxide. Alkyls that are particularly preferred for use in an EAA-CO compound that is to be used for semi conductive layers that are strippable from copolymer isolators of the mentioned types are, e.g., methyl, ethyl, propyl, butyl, pentyl and hexyl, of which methyl, ethyl and butyl are more preferred, and butyl is the most preferred as it is relatively highly polar and readily available at a reasonable cost.

The invention has mainly been described above with reference to a few embodiments. However, as is readily appreciated by a person skilled in the art, other embodiments than the ones disclosed above are equally possible within the scope of the invention, as defined by the appended patent claims.

For example, NBR, even though it contributes to the strippability to some extent, is not an essential component in a strippable semi conductive coating. It is preferred, though, since it improves the extrusion properties, such as the viscosity, of the composition.

Also other types of carbon black than Vulcan XC500 may, obviously, be used for obtaining the correct resistivity of the semi conductive layer, but the fraction of carbon black in the semi conductive material may need to be adjusted accordingly.

Even though ethylene-alkyl acrylates are used in the detailed examples above, also ethylene-alkyl methacrylates are suitable. Both alternatives are covered by the term “ethylene-alkyl(meth)acrylate” of the appended claims.

And even though, in the foregoing, a strippable copolymer layer comprising ethylene-alkyl(meth)acrylate carbon monoxide has been described in detail, a strippable copolymer layer may also be formed by polymerizing a composition of comonomers for forming such a copolymer; such compositions of comonomers are also covered by the appended claims.

The semi conductive polymer mixture described in detail hereinbefore may also be applied to other insulator compositions than those described in detail above; strippability is also obtained when applied to insulators of EPR and/or polyethylene homopolymers.

1. A cable for transmitting electrical power at a voltage between 5 and 49 kV, comprising
a conductive cable core;
an insulation layer to insulate the cable core, the insulation layer comprising
from 50 to 99.9% by weight of polyethylene, and
from 0.1 to 50% by weight of at least one copolymer selected from the group consisting of ethylene-alkyl(meth)acrylates and ethylene vinyl acetate; and
an outer semi conductive screen, forming an outer layer on the insulation layer, and comprising from 20 to 80% by weight of a composition of at least one copolymer selected from the group consisting of ethylene-alkyl (meth)acrylate carbon monoxides.

2. A cable according to claim 1, wherein the insulation layer comprises from 50 to 90% by weight of polyethylene and from 10 to 50% by weight of at least one copolymer selected from the group consisting of ethylene-alkyl(meth)acrylates and ethylene vinyl acetate.

3. A cable according to claim 1, wherein the outer semi conductive screen comprises from 30 to 70% by weight of said composition of at least one copolymer selected from the group consisting of ethylene-alkyl(meth)acrylate carbon monoxides.

4. A cable according to claim 1, wherein the outer semi conductive screen presents an adhesion to the insulation layer of from 5 to 50 N/cm, and more preferably from 10 to 30 N/cm.

5. A cable according to claim 1, wherein said at least one copolymer selected from the group consisting of ethylene-alkyl(meth)acrylate carbon monoxides, of said composition, comprises
from 25 to 70% by weight of ethylene;
from 20 to 50% by weight of at least one alkyl(meth)acrylate; and
from 5 to 25% by weight of carbon monoxide.

6. A cable according to claim 5, wherein said at least one copolymer selected from the group consisting of ethylene-alkyl(meth)acrylate carbon monoxides, of said composition, comprises from 25 to 50% by weight of at least one alkyl(meth)acrylate.

7. A cable according to claim 1, wherein an alkyl of said at least one copolymer selected from the group consisting of ethylene-alkyl(meth)acrylate carbon monoxides, of said composition, is butyl.

8. A cable according to claim 1, wherein said polyethylene is a low-density polyethylene.

9. A cable according to claim 1, wherein the outer semi conductive screen further comprises
from 5 to 30% by weight of NBR; and
from 20 to 40% by weight of carbon black.

10. A cable according to claim 9, wherein the outer semi conductive screen comprises from 30 to 40% by weight of carbon black.

11. A polymer mixture for preparing an outer semi conductive screen for a cable, the polymer mixture comprising
from 5 to 30% by weight of NBR;
from 20 to 40% by weight of carbon black; and
from 20 to 80% by weight of a composition of at least one copolymer selected from the group consisting of ethylene-alkyl(meth)acrylate carbon monoxides, or of a composition of comonomers for forming a copolymer selected from the group consisting of ethylene-alkyl(meth)acrylate carbon monoxides.

12. A polymer mixture according to claim 11, comprising from 30 to 70% by weight of said composition of at least one copolymer selected from the group consisting of ethylene-alkyl(meth)acrylate carbon monoxides, or of said composition of comonomers.

13. A polymer mixture according to claim 11, comprising from 30 to 40% by weight of carbon black.

14. A polymer mixture according to claim 11, wherein said at least one copolymer selected from the group consisting of ethylene-alkyl(meth)acrylate carbon monoxides, of said composition, or said composition of comonomers, comprises
from 25 to 70% by weight of ethylene;
from 20 to 50% by weight of at least one alkyl(meth)acrylate; and
from 5 to 25% by weight of carbon oxide.

15. A polymer mixture according to claim 14, wherein said at least one copolymer selected from the group consisting of ethylene-alkyl (meth)acrylate carbon monoxides, of said composition, or said composition of comonomers, comprises from 25 to 50% by weight of at least one alkyl (meth)acrylate.

16. A polymer mixture according to claim 11, wherein an alkyl of said at least one copolymer selected from the group consisting of ethylene-alkyl(meth)acrylate carbon monoxides, of said composition, or an alkyl of said composition of comonomers, is butyl.

17. A method for reducing the adhesive force between copolymer layers in a cable, comprising:
using a copolymer selected from the group consisting of ethylene-alkyl (meth)acrylate carbon monoxides.

18. The method according to claim 17, wherein said copolymer selected from the group consisting of ethylene-alkyl (meth)acrylate carbon monoxides comprises
from 25 to 70% by weight of ethylene;
from 20 to 50% by weight of at least one alkyl(meth)acrylate; and
from 5 to 25% by weight of carbon oxide.

19. The method according to claim 17, wherein an alkyl of said at least one copolymer selected from the group consisting of ethylene-alkyl(meth)acrylate carbon monoxides is butyl.

20. The cable according to claim 4, wherein the outer semi conductive screen presents an adhesion to the insulation layer of from 10 to 30 N/cm.

21. A polymer mixture according to claim 112, comprising from 30 to 40% by weight of carbon black.

22. The method according to claim 18, wherein an alkyl of said at least one copolymer selected from the group consisting of ethylene-alkyl (meth)acrylate carbon monoxides is butyl.
